(19) United States
(12) Patent Application Publication
(10) Pub. No.: US 2010/0273531 A1
(43) Pub. Date: Oct. 28, 2010

(54) ELECTRONIC DEVICE

(76) Inventor: Song-Yuan Hu, Penghu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/465,657

(22) Filed: May 14, 2009

(30) Foreign Application Priority Data
Apr. 22, 2009 (TW) 98113361

(51) Int. Cl. H04M 1/00

(52) U.S. Cl. 455/566

(57) ABSTRACT

An electronic device includes a first housing, a second housing and an aberration compensating chip. The first housing has a first display screen, and the second housing connected to the first housing has a second display screen, wherein the first display screen can be joined with the second display screen and a seam located at the joining place between the first display screen and the second display screen is formed. The aberration compensating chip disposed in the first housing or in the second housing is electrically connected to the first display screen and the second display screen. When the second housing moves relative to the first housing so as to simultaneously expose the first display screen and the second display screen for displaying images, the aberration compensating chip makes the seam trace between the first display screen and the second display screen invisible so as to display a complete image.

### CROSS-REFERENCE TO RELATED APPLICATION

This application claims the priority benefit of Taiwan application serial no. 98113361, filed on Apr. 22, 2009. The entirety of the above-mentioned patent application is hereby incorporated by reference herein and made a part of specification.

### BACKGROUND OF THE INVENTION

1. Field of the Invention

The present invention generally relates to an electronic device, and more particularly, to an electronic device having a plurality of display screens to expand the display area.

2. Description of Related Art

The electronic devices today, such as cell phone, personal digital assistant (PDA), game machine, MP3 (MPEG-1 audio layer 3), GPS (global positioning system) or digital camera, employ display screen, so as to make a user conveniently master the present status of the electronic device or play game with the electronic device.

Although different types of electronic devices have different sizes, under the modem trend of pursuing light, slim, short and small figure thereof. However, the dimension of a display screen employed by different electronic devices still is restricted by the total dimension of each electronic device. In fact, the display screen size today, in general speaking, does not meet the demand of the consumers. As a user, an electronic device with light, slim, short and small figure in addition to a larger-and-larger display screen employed by the electronic device is really expected.

### SUMMARY OF THE INVENTION

Accordingly, the present invention is directed to an electronic device having a plurality of display screens for compositely forming an increased display area.

The present invention provides an electronic device, which includes a first housing, a second housing and an aberration compensating chip. The first housing has a first display screen, and the second housing is connected to the first housing and has a second display screen, wherein the first display screen can be joined with the second display screen and there is a seam located at the joining place between the first display screen and the second display screen. The aberration compensating chip is disposed in the first housing or in the second housing and is electrically connected to the first display screen and the second display screen. When the second housing moves with respect to the first housing so as to simultaneously expose the first display screen and the second display screen for displaying images, the aberration compensating chip makes the seam trace between the first display screen and the second display screen invisible so as to display a complete image.

In an embodiment of the electronic device of the present invention, the above-mentioned second housing is disposed in sliding way at or pivoted on the first housing.

In an embodiment of the present invention, the above-mentioned electronic device further includes a first circuit board disposed in the first housing and electrically connected to the first display screen. Besides, the electronic device further includes a second circuit board disposed in the second housing and electrically connected to the second display screen and the first circuit board. The above-mentioned aberration compensating chip can be electrically connected to the first circuit board or the second circuit board.

In an embodiment of the present invention, the above-mentioned electronic device further includes a first battery disposed in the first housing and electrically connected to the first circuit board. In addition, the electronic device further includes a second battery disposed in the second housing and electrically connected to the second circuit board.

Based on the described above, the invented electronic device has a plurality of small display screens and the small display screen can be compositely joined with each other to form a larger display screen for displaying a complete image, which contributes to solve the problem of insufficient screen size with electronic devices today.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an electronic device in folding status according to the first embodiment of the present invention.

FIG. 2 is a diagram of the electronic device of FIG. 1 in opening status.

FIG. 3 is a diagram of an electronic device with two display screens thereof being compositely joined with each other to display a complete image.

FIG. 4 is a diagram of an electronic device according to the second embodiment of the present invention.

FIG. 5 is a side view diagram of the electronic device of FIG. 4 with the second housing sliding in parallel way to the first housing.

FIG. 6 is a side view diagram of the electronic device of FIG. 4 with the second housing sliding in perpendicular way to the first housing.

FIG. 7 is a diagram of the electronic device of FIG. 4 with the second housing being opened with respect to the first housing.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

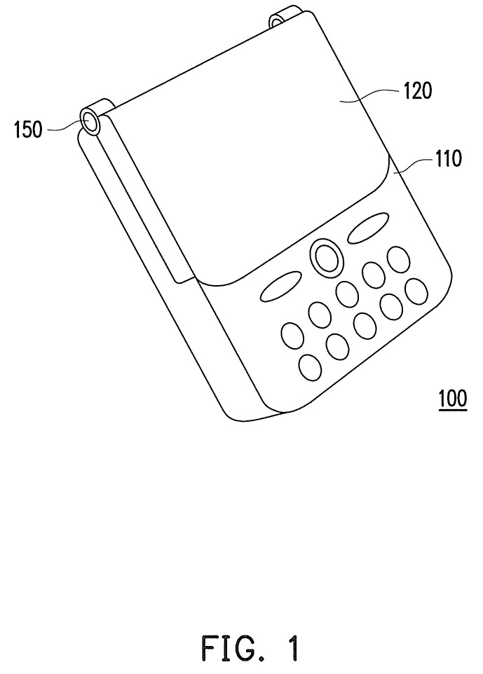

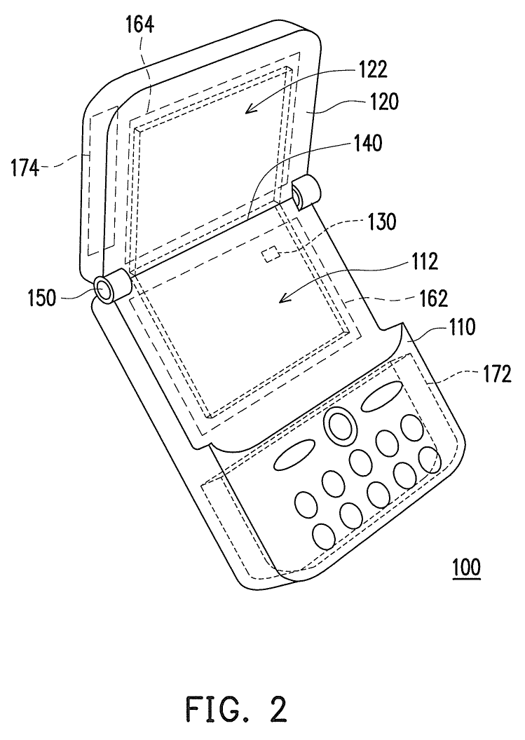

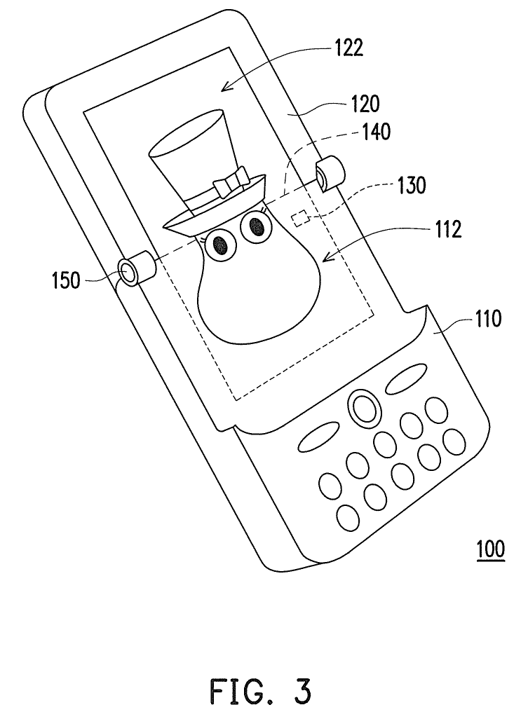

FIG. 1 is a diagram of an electronic device in folding status according to the first embodiment of the present invention, FIG. 2 is a diagram of the electronic device of FIG. 1 in opening status and FIG. 3 is a diagram of an electronic device with two display screens thereof being compositely joined with each other to display a complete image. Referring to FIGS. 1, 2 and 3, an electronic device 100 includes a first housing 110, a second housing 120 and an aberration compensating chip 130. The first housing 110 has a first display screen 112, the second housing 120 is connected to the first housing 110 and has a second display screen 122, and the first display screen 112 can be joined with the second display screen 122, wherein there is a seam 140 located at the joining place between the first display screen 112 and the second display screen 122. The aberration compensating chip 130 is disposed in the first housing 110 and is electrically connected to the first display screen 112 and the second display screen 122. When the second housing 120 moves with respect to the first housing 110 so as to simultaneously expose the first display screen 112 and the second display screen 122 for displaying images, the aberration compensating chip 130 makes the seam trace between the first display screen 112 and the second display screen 122 invisible so as to display a complete image (as shown in FIG. 3).

In the embodiment, the second housing 120 is pivoted on the first housing 110 and is able to swing around a pivoting shaft 150 with respect to the first housing 110 for unfolding or folding. When the second housing 120 and the first housing 110 are folded, the second display screen 122 and the first display screen 112 fitly touch each other, wherein the areas of the first display screen 112 and the second display screen 122 can be the same or different, and the shapes thereof can be the same or different, depending on the design requirement.

When the second housing 120 is opened with respect to the first housing 110 to make both the second display screen 122 and the first display screen 112 level with each other, the first display screen 112 and the second display screen 122, both of which are linked with each other from two originally separated parts but remain a trace of the seam 140. Meanwhile, the aberration compensating chip 130 is able to compensate the aberration and make the trace of the seam 140 between the first display screen 112 and the second display screen 114 invisible. In other words, although the first display screen 112 and the second display screen 122 are compositely joined with each other, but what the user sees is a complete image without the trace of the seam 140. In comparison with the prior art, the electronic device 100 of the embodiment has no significant difference from a conventional electronic device, but the electronic device 100 gains a larger display area to better meet the demand of the user.

The electronic device 100 further includes a first circuit board 162 disposed in the first housing 110 and electrically connected to the first display screen 112. The above-mentioned aberration compensating chip 130 can be disposed on the first circuit board 162 and electrically connected to the first circuit board 162. The first circuit board 162 can further electrically connect the second display screen 122, so that the first display screen 112 and the second display screen 122 after compositely joining get an electrical control through the first circuit board 162 so as to together display images.

The electronic device 100 can further include a second circuit board 164, wherein the second circuit board 164 is disposed in the second housing 120 and electrically connected to the second housing 120 and the first circuit board 162. Differently from the described above, where when the electronic device 100 employs the first circuit board 162 only, the first circuit board 162 disposed in the electronic device 100 simultaneously controls the first display screen 112 and the second display screen 122 for together displaying images; while the electronic device 100 herein employs both the first circuit board 162 and the second circuit board 164 disposed in the electronic device 100, so that both the first display screen 112 and the second display screen 122 could be controlled by the circuit boards 162 and 164 respectively for together displaying images. In addition, the aberration compensating chip 130 can be disposed on the first circuit board 162 or the second circuit board 164 depending on the design requirement (in FIG. 2, the aberration compensating chip 130 is disposed on the first circuit board 162). Besides, the first circuit board 162 and the second circuit board 164 can be electrically connected to each other through a flat-cable or a film circuit.

The electronic device 100 can further include a first battery 172 disposed in the first housing 110 and electrically connected to the first circuit board 162. The first battery 172 serves as a power source to feed the circuit of the first circuit board 162 for running and enable the first display screen 112 and the second display screen 122 for displaying images. The electronic device 100 can further include a second battery 174 disposed in the second housing 120 and electrically connected to the second circuit board 164. The second battery 174 is able to enhance the electrical power for the electronic device 100 and lengthen the operation time of the electronic device 100.

It can be seen from the described above, the electronic device 100 of the embodiment has the same figure and volume as the conventional ones, but the electronic device 100 herein gains a larger display area to better meet the demand of users. It should be noted that although only two display screens are exemplarily depicted for compositely forming a larger screen, but anyone skilled in the art can easily select a number of the display screens other than two to meet the design requirement. Similarly, the housings employing the display screens can be connected to each other in other ways.

### The Second Embodiment

The embodiment is almost the same as the first embodiment except that the first housing and the second housing are connected in another way. The connection way does not affect the dispositions of the aberration compensating chip, the batteries and the circuit boards. In term of the dispositions of the aberration compensating chip, the batteries and the circuit boards, they can refer to the depiction of the first embodiment, which is omitted to describe.

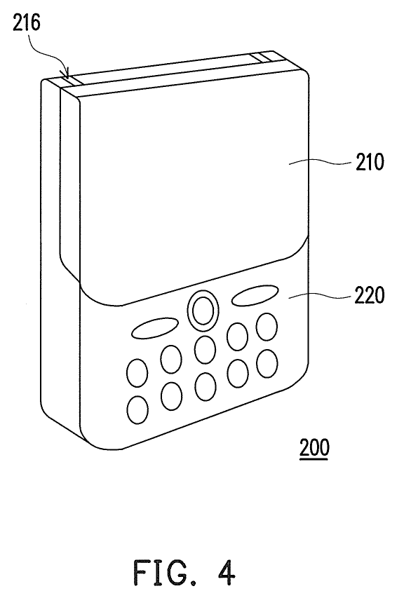

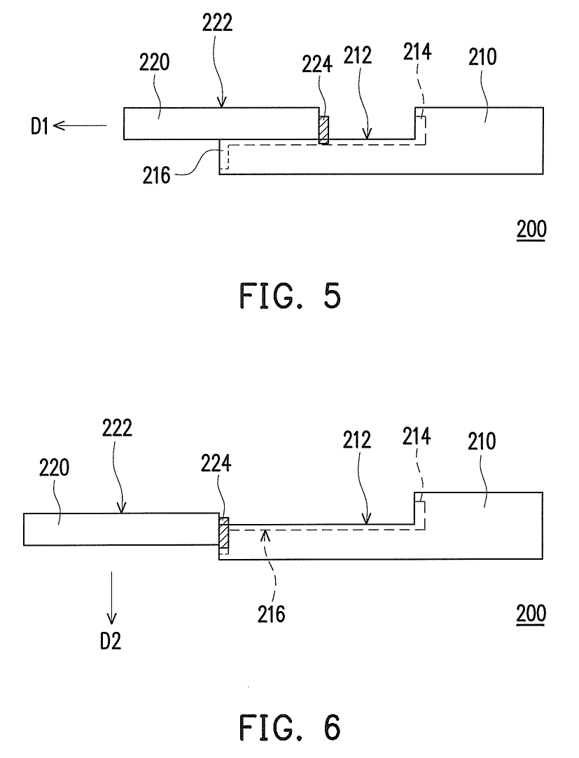

FIG. 4 is a diagram of an electronic device according to the second embodiment of the present invention, FIG. 5 is a side view diagram of the electronic device of FIG. 4 with the second housing is sliding in parallel way to the first housing and FIG. 6 is a side view diagram of the electronic device of FIG. 4 with the second housing is sliding in perpendicular way to the first housing. In the electronic device 200 of the embodiment, the second housing 220 is connected to the first housing 210 in sliding way. Referring to FIGS. 4, 5 and 6, the first housing 210 further has a plurality of positioning notches 214 and a plurality of sliding rails 216, and the second housing 220 further has a plurality of tabs 224, wherein the tabs 224 are disposed correspondingly to the positioning notches 214 and the sliding rails 216.

Referring to FIGS. 4 and 5, when the second housing 220 and the first housing 210 are folded, the first display screen 212 and the second display screen 222 fitly touch each other. Meanwhile, the tabs 224 of the second housing 220 are respectively locked in the corresponding positioning notches 214 of the first housing 210, so that the second housing 220 and the first housing 210 are fixed by each other. Then, the user can push the second housing 220 by hand to make the second housing 220 slide in parallel way to the first housing 210. In more details, at the time, the tabs 224 of the second housing 220 horizontally move in the sliding rails 216 of the first housing 210 along a direction D1. Then, as shown by FIG. 6, the tabs 224 of the second housing 220 vertically move in the sliding rails 216 of the first housing 210 along a direction D2 until the first display screen 212 and the second display screen 222 are in a same plane.

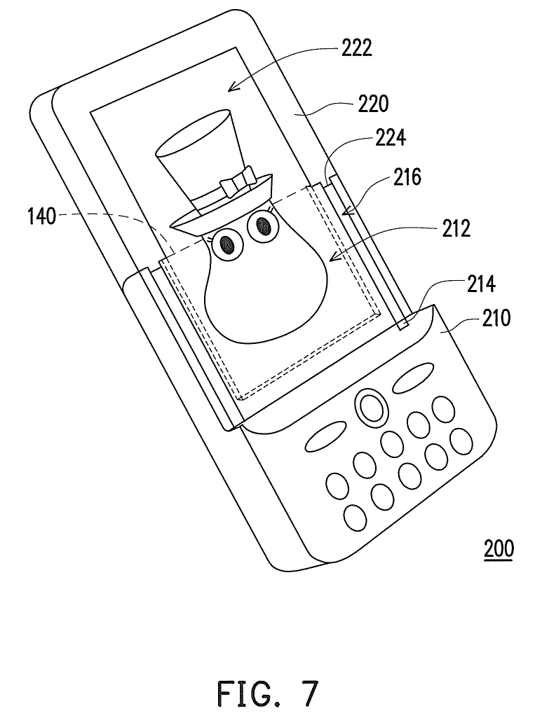

FIG. 7 is a diagram of the electronic device of FIG. 4 with the second housing being opened with respect to the first housing. Referring to FIG. 7, the first display screen 212 and the second display screen 222 are together displaying a complete image.

Although only two display screens are used in the embodiment for compositely forming a larger screen and only two housings are employed and connected to each other through sliding rails or pivoting shaft, but people skilled in the art can easily select other connection ways between the first housing 210 and the second housing 220 and select a number of the display screens other than two to gain a larger display area.

In summary, the electronic device of the present invention has a plurality of small display screens and the small display screen can be compositely joined with each other to form a larger display screen for displaying a complete image, which contributes to solve the problem of insufficient screen size with electronic devices today to better meet the demand of users. In addition, when compositely joining the display screens, the trace of the seam in the electronic device is invisible by employing an aberration compensating chip, so that the complete image can be displayed in a larger area.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An electronic device, comprising:
a first housing, having a first display screen;
a second housing, connected to the first housing and having a second display screen, wherein the first display screen and the second display screen are joined with each other and there is a seam located at the joining place between the first display screen and the second display screen; and
an aberration compensating chip, disposed in the first housing or in the second housing and electrically connected to the first display screen and the second display screen, wherein when the second housing moves with respect to the first housing so as to simultaneously expose the first display screen and the second display screen for displaying images, the aberration compensating chip makes the seam trace between the first display screen and the second display screen invisible so as to display a complete image.

2. The electronic device as claimed in claim 1, wherein the second housing is disposed in sliding way at or pivoted on the first housing.

3. The electronic device as claimed in claim 1, further comprising a first circuit board disposed in the first housing and electrically connected to the first display screen.

4. The electronic device as claimed in claim 3, wherein the aberration compensating chip is electrically connected to the first circuit board.

5. The electronic device as claimed in claim 3, further comprising a second circuit board disposed in the second housing and electrically connected to the second display screen and the first circuit board.

6. The electronic device as claimed in claim 5, wherein the aberration compensating chip is electrically connected to the second circuit board.

7. The electronic device as claimed in claim 1, further comprising a first battery disposed in the first housing and electrically connected to the first circuit board.

8. The electronic device as claimed in claim 7, further comprising a second battery disposed in the second housing and electrically connected to the second circuit board.
